(19) United States
(12) Patent Application Publication
(10) Pub. No.: US 2021/0125274 A1
(43) Pub. Date: Apr. 29, 2021

(54) SYSTEM AND METHOD FOR AUTOMATIC SAVINGS AND DEBT PAYDOWN

(71) Applicant: KeyBank National Association, Cleveland, OH (US)

(72) Inventors: Elizabeth Ann Molloy de Coluby, Beachwood, OH (US); Michael L. Wesley, Hudson, OH (US); Robert M. Biggar, Cleveland, OH (US); Philip M. Jackey, Indianapolis, IN (US); William Samuel Sellery, Avon, OH (US)

(21) Appl. No.: 17/078,696

(22) Filed: Oct. 23, 2020

Related U.S. Application Data
(60) Provisional application No. 62/925,573, filed on Oct. 24, 2019.

(51) Int. Cl. G06Q 40/02

(52) U.S. Cl. CPC G06Q 40/02

(57) ABSTRACT

A system for automatic savings and debt paydown includes a first and second bank accounts belonging to a user and a financial account belonging to the user, wherein the financial account may be one of the first bank account or second bank account. A user interface provides the user with an option to select one of a savings mode or a debt paydown mode. A preset amount of monetary funds is automatically transferred from the first bank account to the second bank account when a transaction involving the financial account occurs. Moreover, if the debt paydown mode has been selected by the user via the user interface, at the end of a set period, all monetary funds transferred from the first bank account to the second bank account as a result of transactions involving the financial account during that period are transferred to a debt payee specified by the user.

### RELATED APPLICATIONS

This application claims priority to U.S. Provisional Application Ser. No. 62/925,573, filed Oct. 24, 2019.

### BACKGROUND

Generally, consumers have financial goals that can be described by three primary types—(1) saving for a goal, including emergency savings, (2) paying down debt or (3) investing for the future. According to at least one study, 75% of United States consumers carry debt. Debt is at an all-time high, according to some sources, as much as $135,000 per consumer. Moreover, a recent survey of the United States Federal Reserve found that 40% of Americans do not have enough funds saved to cover a $400 emergency expense. To be financially well, a consumer needs to save more and reduce their debt to reasonable levels relative to their income and assets.

There are several hurdles that make it difficult for consumers to attain financial wellness. Foremost, the necessities of daily life often make savings and debt paydown difficult for consumers. Many consumers are simply too caught up in their daily routines—family, work, bills, etc.—to even give thought to the state of their savings or accelerating their debt paydown. Moreover, when faced with a choice in the moment of spending funds on savings or debt paydown, versus an immediate purchase, many consumers will choose the latter and forgo savings. Accordingly, consumers could benefit greatly from a tool that would automate their savings and/or debt paydown, without the consumer having to take any direct action other than making the normal purchases they would make anyway on daily basis.

While there may be some existing tools to help a consumer save or invest without the consumer taking direct action, these tools lack the flexibility to allow the consumer to switch between a financial wellness goal of savings and automated debt payments. Most importantly, most of the existing tools stop at savings and do not provide any ability to automate payments to a debt of the consumer's choice. Another major drawback of existing savings tools is that the balances are maintained at another financial institution, not their primary bank, so access to the funds has a time delay that prevents drawing those funds in an emergency, could stall debt payments using those funds, and may result in lower interest earned in interest bearing accounts. It would be far more beneficial if the consumer could maintain control and access of the funds saved at all times.

### SUMMARY OF THE INVENTION

According to an embodiment, a system for automatic savings and debt paydown includes a first bank account belonging to a user, a second bank accounts belonging to the user and a financial account belonging to the user, wherein the financial account may be one of the first bank account or second bank account. A user interface provides the user with an option to select one of a savings mode or a debt paydown mode. A preset amount of monetary funds is automatically transferred from the first bank account to the second bank account when a transaction involving the financial account occurs. Moreover, if the debt paydown mode has been selected by the user via the user interface, at the end of a set period, all monetary funds transferred from the first bank account to the second bank account as a result of transactions involving the financial account during that period are transferred to a debt payee specified by the user.

### DESCRIPTION OF THE FIGURES

FIG. 1 is system diagram of an embodiment of an exemplary automatic savings system according to the present disclosure.

FIGS. 2a-2f are a set of screenshots of an exemplary user interface according to the present disclosure.

FIG. 3 is system diagram of another embodiment of the exemplary automatic savings system according to the present disclosure.

FIG. 4 is a flowchart illustrating an exemplary method for enrollment in the exemplary automatic savings system according to the present disclosure.

FIG. 5 is a flowchart illustrating an exemplary method for calculating and transferring funds in the exemplary automatic savings system according to the present disclosure.

FIG. 6 is a flowchart illustrating an exemplary method for providing debt payments in the exemplary automatic savings system according to the present disclosure.

FIG. 7 is schematic diagram illustrating data flow between components of the exemplary automatic savings system according to the present disclosure.

### DETAILED DESCRIPTION

The present disclosure describes a system and method that enables consumers to save in small increments, building up their savings by making micro-transfers from a checking account to a savings account. The consumer then also has a choice: they can either use those micro-transfers to grow their savings balance or automatically use an accumulated amount of micro-transfers to make an extra payment to a debt of the consumer's choice. These additional payments enable the consumer to pay down their debt faster. The system and method are designed such that a consumer can easily enroll in the automatic savings program, alter their enrollment, pause or unenroll, and also help the consumer avoid incurring any fees for insufficient funds or other issues. The system and method are further designed to centralize the transactions and processing at a single merchant, to make transactions and reporting simpler and more efficient.

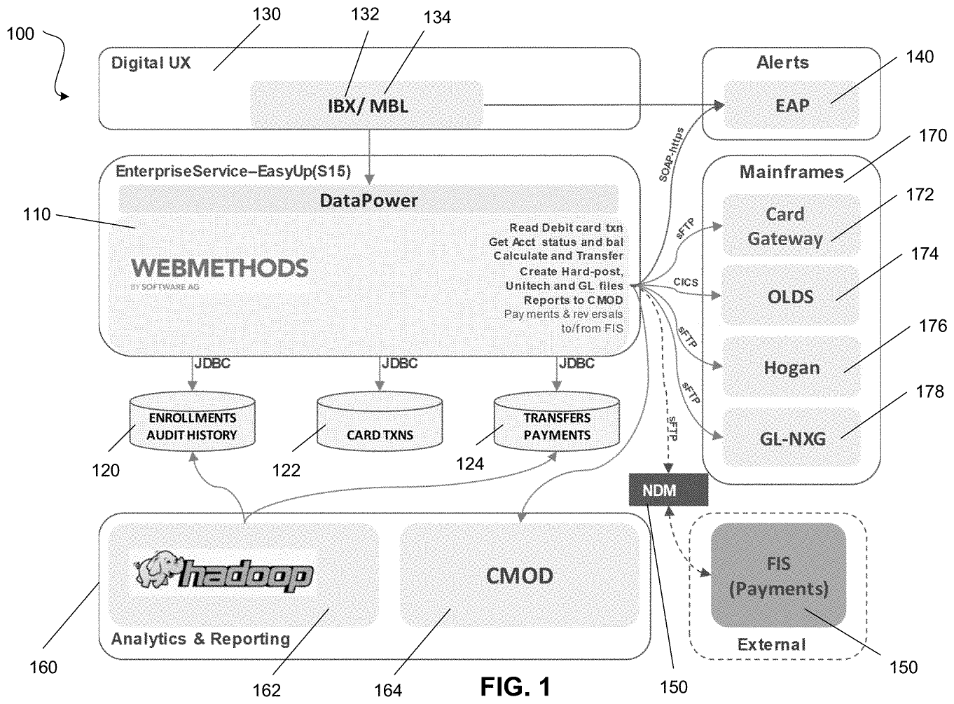

FIG. 1 depicts an exemplary automatic savings system 100 according to the present disclosure. The automatic savings system 100 includes several components. Central to the system 100 is the automatic savings service 110. The automatic savings service 110 integrates the many other components discussed herein and facilitates processing and transfer of data between the many components. In the exemplary embodiment of FIG. 1, the automatic savings service 110 is implemented via an IBM DataPower Gateway running an AG WebMethods Integration Server. The logic of the automatic savings service 110 may be implemented using any suitable programming language, for example, Java, C, C++ or the like.

The automatic savings service 110 is connected to one or more data sources. For example, the automatic savings service 110 may be connected to enrollment database 120, which stores customer enrollment information, such as customer identification, personal information, and information relating to the customer's automatic savings program, which is described in more detail below. The automatic savings service 110 may be further connected to one or more transaction databases 122, which store transaction information, for example, but not limited to, debit or credit card purchases, bill payments, or account transfers for accounts linked to the customer's automatic savings program. The automatic savings service 110 may be further connected to a funds transfer database 124, which stores details relating to transfers made between the customer's accounts resulting from the automatic savings program, such as date and time, amount, account information, and other identifying information.

While the data sources 120, 122 and 124 are shown as separate databases in the exemplary automatic savings system 100, it is contemplated that the same data can be stored in single database or divided among any number of databases. Moreover, while the exemplary automatic savings service 100 depicts the data sources 120, 122 and 124 being connected to the automatic savings service 110 via a Java Database Connectivity API, any suitable API or other connection may be used to connect the data sources. Moreover, in some embodiments, the data sources 120, 122 and 124 may be integrated into the automatic savings service 110.

More specifically, the enrollment database 120 stores information relating to a customer's enrollment in the automatic savings program, such as bank account identifiers, linked payment cards, transfer amounts, and cumulative statistics. For example, the enrollment database 120 may a store a month-to-date amount for each customer, which is the amount of money transferred from a selected checking account to a selected savings account under the program since the start of current monthly period, and the amount that will be paid to a debt payee when the current period ends, if debt payment is active. The month-to-date amount may be reset to zero at the first of each month or on another day selected by the merchant or the customer, whether or not a debt payment is made on that day. The enrollment database 120 may further store an enrollment-to-date amount, which is the amount of money transferred from a selected checking account to a selected savings account under the program. The enrollment-to-date amount may be reset to zero if the customer unenrolls from the automatic savings program and will start again from zero if that customer reenrolls. The methods for enrolling, transferring funds and making debt payments are described in further detail below.

Generally, customers' point of contact with the automatic savings system 100 is through an internet banking system 130. The internet banking system 130 may be accessed through personal computer 132 and/or a mobile device 134, such as laptop computer, tablet computer, telephone or the like. In some embodiments, the internet banking system 130 may be implemented as a software-as-a-service application, accessible via a web browser of the personal computer 132 or mobile device 134. In some embodiments, an access portal to the internet banking system 130 may be in the form of software installed on the personal computer 132 or mobile device 134, and the software may be different for each device, being specifically tailored for each different device.

At a high level, the internet banking system 130 allows a user to interact with banking accounts, loans and associated programs. For example, the internet banking system 130 may allow a user to create and manage checking, savings, money market and other accounts, to manage loans such as mortgages, equity or credit lines and the like, to transfer funds between accounts, and access account statements and tax documents. Pertinent to the present disclosure, the internet banking system 130 also allows a user to enroll in the automatic savings system disclosed herein, as well as to access and modify their enrollment in the system. Enrollment and access to the automatic savings system is not meant to be limited only to a customer portal through the internet banking system 130. For example, a customer may also enroll or access information by visiting a physical banking location or calling the call center and receiving assistance from bank employee, who may access the system through an internal network, internal software portal, or other suitable means. Moreover, some or all data available through the internet banking system 130 may be available to the merchant controlling the system 100 through an internal portal for marketing and other purposes.

As described above, user may enroll in the automatic savings system through the internet banking system 130. The automatic savings system 100 may be associated with a number of different banking accounts, debit or credit cards and debt accounts. Accordingly, at the time of enrollment, the internet banking system 130 may present the user with a series of inquiries, asking the customer which accounts should be linked to the system, as well as other details regarding their enrollment in the automatic savings program.

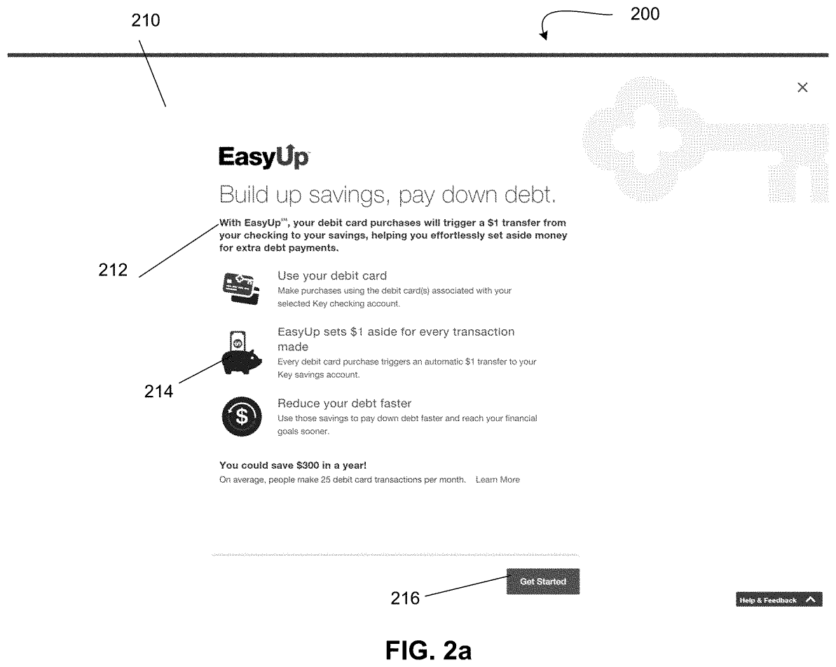

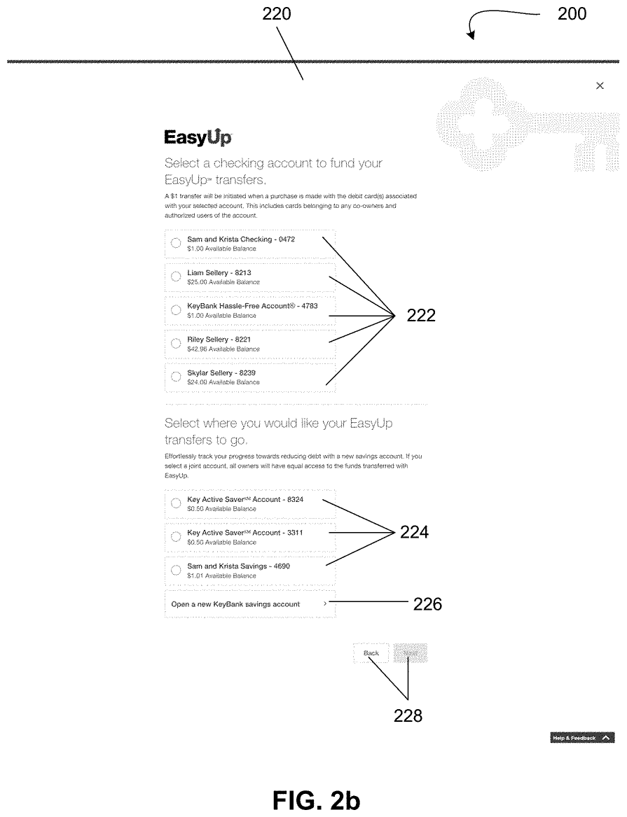

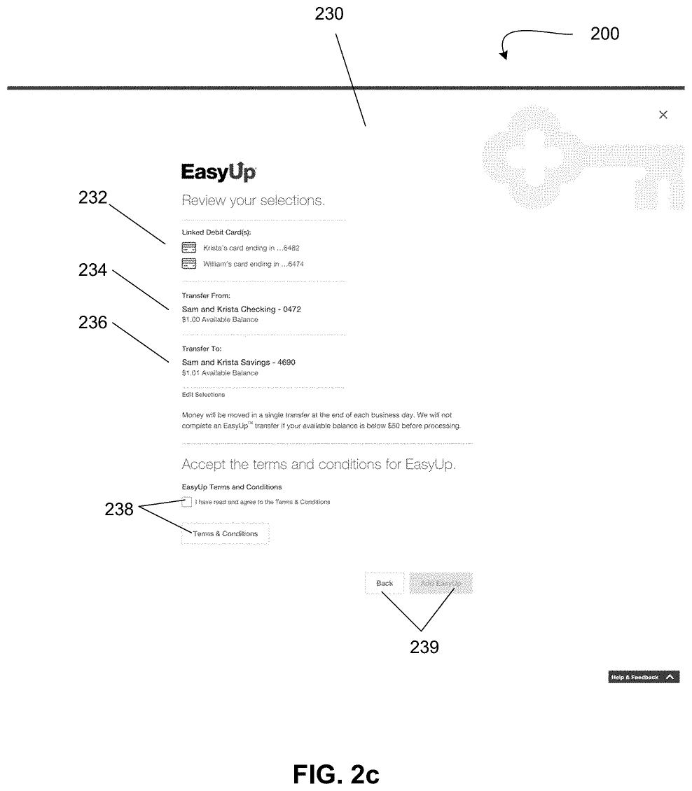

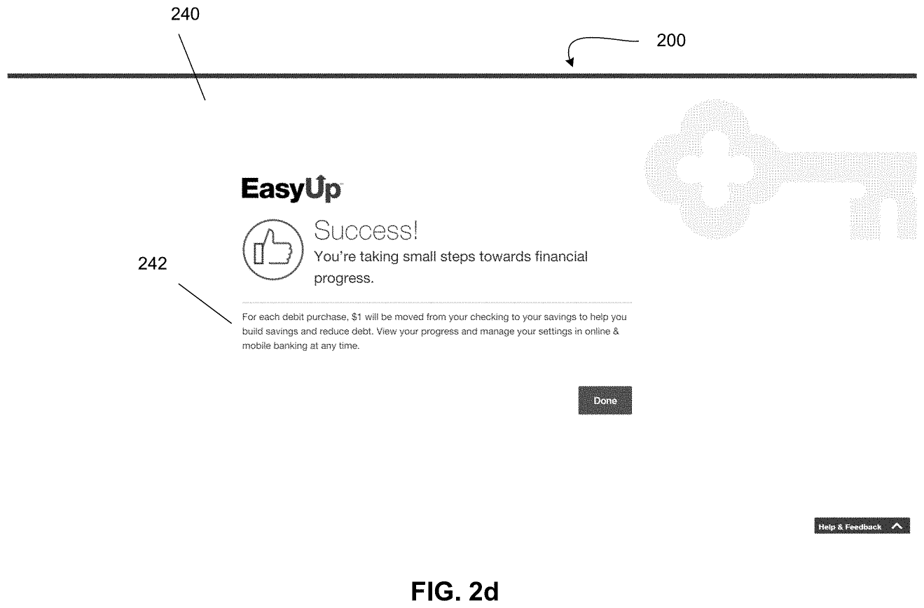

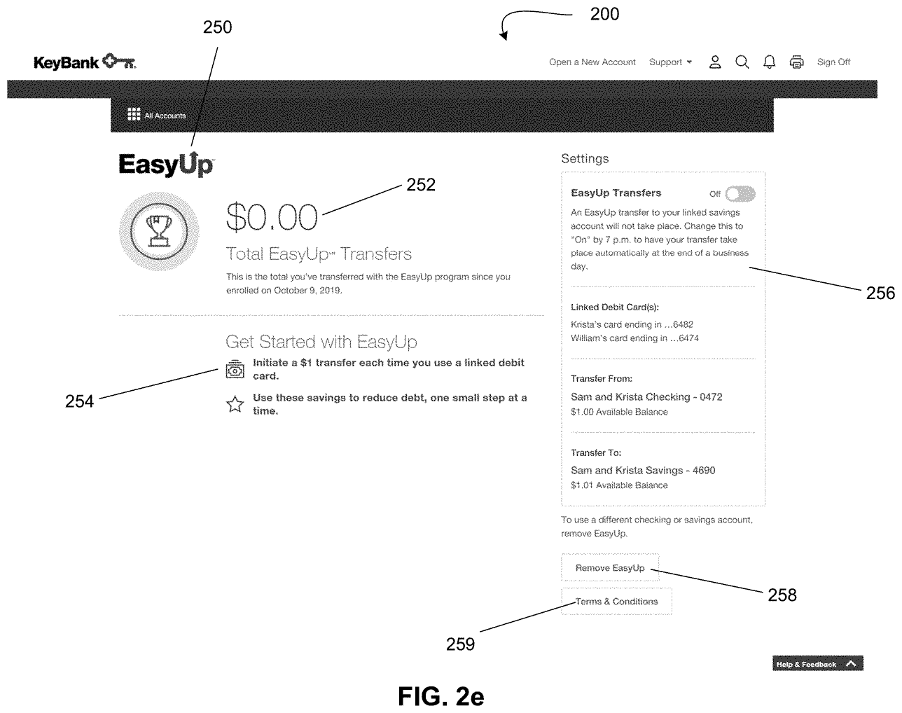

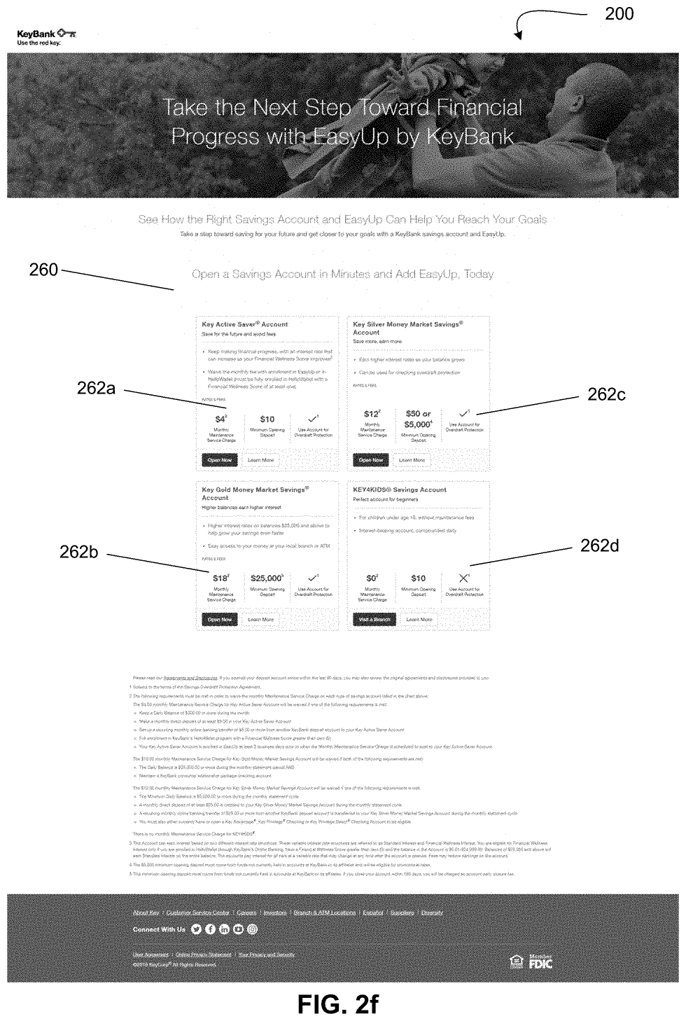

FIGS. 2a-2f depict exemplary screenshots of the automatic savings program user interface 200 of the internet banking system 130 for a mobile device 134. Other layouts and arrangements are contemplated, and the user interface 200 may be different for an installed version on a personal computer 122, or a web-browser-based version. As illustrated in FIG. 2a, the exemplary user interface 200 may include a welcome screen 210, which in some embodiments includes welcome text 212, a summary of one or more current settings of the automatic savings program, such as the automatic transfer amount 214, and buttons, links or other user interfaces 216 where a user can assent to participate in the automatic savings program and continue to additional screens described below to set up their automatic savings program.

As depicted in FIG. 2b, the exemplary user interface 200 may further include a setup screen 220 that allows a user to set or change certain parameters associated with the automatic savings program. For example, setup screen 220 includes a first account selection 222, which represents the account from which funds will be automatically withdrawn. The setup screen 220 further includes a second account selection 224, which represents the account into which the automatically withdrawn funds will be deposited. While the exemplary first and second account selections 222 and 224 are shown as radio button selections, other known selection methods may be used, such a list with checkboxes, dropdown selection boxes, a selectable list box, etc. The exemplary first and second account selections 222 and 224 may show information relating to available accounts, such as the current balance of each account. In some embodiments, only eligible accounts (as explained further below) are shown as selectable options for the first and second account selections 222 and 224. In some embodiments, all of a customer's accounts are shown, but ineligible accounts are greyed out or otherwise unselectable. Furthermore, the setup screen 220 may provide text to explain why such accounts are ineligible elsewhere on the screen, or as popup text via a mouse click, hover, tap or the like. The setup screen 220 may also provide a link 226 to an online account-opening system. Users can then create one or more eligible accounts, and the online account-opening system may provide a link back to the setup screen 220 to complete enrollment in the automatic savings program. Finally, the setup screen 220 may include navigation buttons 228, to allow a user to move forward and backward through the various screens of the user interface 200.

In some embodiments, the user interface 200 may provide an automatic savings withdrawal amount selector (not shown), which allows a user to set the amount that will be withdrawn from the account selected via the first account selection 222 and deposited into the account selected via the second account selection 224. The automatic savings withdrawal amount selector may be in the form of a slider, a text entry field or any of the other selection methods described above. In some embodiments, the user interface 200 may provide a suggested amount for the automatic savings withdrawal amount selector. Moreover, the user interface 200 may limit the amount a user can enter into the automatic savings withdrawal amount selector, for example, the user may be restricted to entering an amount between a preset minimum and a preset maximum.

In some embodiments, the user interface 200 may provide an additional triggering transactions list (not shown), which allows a user to select other transactions that will trigger an automatic transfer. For example, a user may link credit cards such that a transaction using the linked credit card will trigger an automatic transfer. As another example, a user may enter a billing account, such as a utility bill or a mortgage account, such that payment of the bill on the linked account will trigger an automatic transfer. In some embodiments, a list of eligible linking accounts is provided to the user based on the user's account information and communication with external databases relating to those accounts. In some embodiments, users may enter their account information and the system will verify whether such account is eligible.

As shown in FIG. 2c, the exemplary user interface 200 may include a review screen 230. The review screen 230 may include a list of linked cards/accounts 232, which are cards and accounts that will trigger an automatic transfer with each transaction. The review screen 230 may also include a first account summary 234 and second account summary 236, which list, respectively, the accounts from which funds for the automatic transfer are drawn and to which funds from the automatic transfer are deposited. The review screen 230 may also include one more required assent forms 238. As shown in the example, required assent forms 238 include a checkbox acknowledging that user has read and agrees to certain terms and conditions and a link to the terms and conditions. In some embodiments, the user may be prevented from completing one or more of the required assent forms 238 (e.g., checking a box) until they have performed some action, such as opening or scrolling completely through the terms and conditions. Finally, the review screen 230 may include navigation buttons 239, which allow a user to go back to another screen of the user interface 200 to make changes to their inputs, or to complete their enrollment in the automatic savings program. In some embodiments, one or more of the navigation buttons may be disabled until the user takes some required actions, for example, the button to complete enrollment may be disabled until all required information on prior screens has been entered and/or all required assent forms 238 have been completed.

In some embodiments, the user interface 200 also includes a debt paydown screen (not shown). The debt paydown screen allows the user to select a debt payee that will receive automatic payments from a customer's selected savings account based on the money automatically saved through the automatic savings program (debt paydown is described in more detail below). The debt paydown screen may further provide the user with a walkthrough of the debt paydown process as well other information and benefits of the program, such as amortization schedules, savings predictions, and more. The debt paydown screen may provide a list of, or access to a list of authorized debt payees, which, for example, may be restricted to debts held by the merchant offering the automatic savings program and/or debts held by known ACH payees in a financial information system 150 in communication with the automatic savings service 110. In the case that no debt payee is selected, the debt paydown screen may default to retaining all funds collected through the automatic savings program in the savings account designated in the setup screen 220.

In some embodiments, the user interface 200 includes a success screen 240, which informs the user of successful completion of enrollment. The success screen 240 may include summary text 242, which may provide a brief summary of how the program works as well as instructions on managing enrollment in the program.

FIG. 2e depicts an embodiment of an information screen 250 that allows a user enrolled in the automatic savings program to view and change aspects of their enrollment. The information screen 250 may include a transfer total 252 that lists the total amount transferred via the automatic savings program to date and may further indicate the date of enrollment. In some embodiments, such as that shown in FIG. 2e, the information screen 250 includes a program overview 254, which may provide a summary of how the automatic savings program works, contact information for ordering new cards to link to the program, and other general information about the program. In some embodiments, the information screen 250 includes a monthly total that lists the total amount of funds transferred via the automatic savings program during the current month period. In some embodiments, the information screen 250 may include additional information, such as the date and/or amount of the next payment to the debt payee and/or the last payment to the debt payee, the current rate of savings using the automatic savings program, and more.

The information screen 250 also includes settings box 256. The settings box 256 may include a display of current settings for the automatic savings program and/or options for changing current settings. For example, the exemplary settings box 256 includes an on/off button that allows a user to pause and un-pause automatic transfers in the automatic savings program. While the exemplary settings box 256 includes only displays for other settings, such as the account from which the transfer is debited, the account to which the transfer is deposited and linked debit/credit cards that trigger the transfer, it is contemplated that the settings box 256 can also contain selection tools like those described above for the other screens of user interface 200 that allow a user to change those and other settings, or links to additional screens that allow a user to change settings of the automatic savings program. Other contemplated settings include, but are not limited to, debt payment options, which are described more fully below, the variable amount per debit transaction, and how the user receives communications relating to the automatic savings program (e.g., mail, email, text message, etc.).

The information screen 250 further includes a removal button 258 that allows a user to withdraw from the automatic savings program. The practical implications of withdrawal are described in more detail below. In an embodiment where settings such as those displayed in settings box 256 are not changeable through the information screen 250, as in exemplary information screen 250, a user may easily change the settings by withdrawing via the button 258 and then simply re-enrolling with the new settings. Finally, the information screen 240 may contain a terms and conditions link 259 that allows a user to review the terms and conditions of the automatic savings program at any time.

In some embodiments, as shown in FIG. 2f, user interface 200 further includes an account signup screen 260 that allows a user to open a new account to use with the automatic savings tool. In the exemplary signup screen 260, the options 262a, 262b, 262c and 262d are provided for opening and/or inquiring about a new savings account. It should be understood that a similar interface may provided for opening a new checking or other account for user with the automatic savings tool.

The exemplary interface shown in FIGS. 2a-2f does not include a detailed transaction history for the various accounts involved in the automatic savings program. It should be understood that a user can gather this information by viewing the transaction histories of each of those accounts. In some embodiments, however, the user interface 200 may provide links to those accounts for easier access by the user. Moreover, it is contemplated that in other embodiments, the user interface 200 may include screens (not shown) that allow a user to view a history of their transactions (e.g., purchases or other actions triggering the automatic savings program, withdrawals made via the automatic savings program, deposits made via the automatic savings program, debt payments made via the automatic savings program, etc.). The transaction history may be presented in a list form as shown in the exemplary screenshot, may be sortable by date or amount or other parameter and may be searchable by date or amount or another parameter. In some embodiments, the transaction history is presented in a multilevel format, where a user can interact with (e.g., touch, click, etc.) a high-level summary of a transaction to drill down for more detail.

Returning back to FIG. 1, the exemplary automatic savings system 100 further includes an alerts module 140. The alerts module 140 sends alerts and other messages to customers via any number of protocols, such as SMTP (email) and SMS (text message). Exemplary alerts and messages include, but are not limited to: a message that a customer was successfully enrolled in the program, an alert that a debt payee was added or changed, alerts when transactions are made, a reminder for an upcoming debt payment, a reminder that payment is being skipped if the program has paused by the customer, an alert if a transfer was canceled due to insufficient funds, and an alert if a debt payment was rejected. Alerts and messages sent via the alerts module 140 may initiate from the automatic savings service 110 or the internet banking system 130, and accordingly the alerts module 140 is in communication with both the automatic savings service 110 and the internet banking system 130. In the exemplary automatic savings system 100, the connection between the automatic savings service 110 and the internet banking system 130 uses Simple Object Access Protocol over a secure http connection, but any suitable connection protocol may be used.

The exemplary automatic savings system 100 further includes a link to an external financial information system 150, which can provide access to information on qualified debt payees for use in the automatic savings program. For example, the financial information system 150 may be used to provide a list of ACH debt payees and to provide information allowing the automatic savings service 130 to provide payments via ACH or otherwise to those debt payees. The financial information system 150 may also provide information back to automatic savings service 130, for example in the event that a debt payment is rejected by the debt payee. In some embodiments, the financial information system 150 is connected to the automatic savings service 130 via a mainframe file-transfer protocol. While in the embodiment shown, the connection to the financial information system 150 is via secure file transfer protocol, any suitable connection means can be used.

The exemplary automatic savings system 100 further includes an analytics and reporting module 160. The analytics and reporting module 160 is responsible for creating and maintaining the many reports that are described in more detail herein. The analytics and reporting module 160 may be split among any number of servers, databases, mainframes and computers, which be linked using a distributed storage framework. While the exemplary automatic savings system 100 shows Hadoop as an example, other suitable framework are contemplated. The analytics and reporting module 160 further includes a report storing component 164. The analytics and reporting module 160 may also be in direct communication with one or more of the data sources 120, 122 and 124 for ease of access to the data for report generation.

The exemplary automatic savings system 100 further includes a set of mainframes 170 that are in communication with the automatic savings service 130. For example, the mainframes 170 may include a transaction gateway 172, which stores all transaction activity (e.g., debit or credit card activity) which is used to calculate the amount of funds to transfer from the checking account to the savings account. The transaction gateway 172 may provide a single file at a time listing transactions each day, or a plurality of transactions through day, or simply a summary or count of transactions for a given account. The transaction gateway 172 is depicted as connected to the automatic savings service 130 via secure file transfer protocol, but other suitably secure connection methods may be used.

The mainframes 170 may further include an online delivery system 174. The online delivery system 174 may be used to validate aspects of user's checking or savings account prior to transfer, such as checking available balances, as described in more detail below. While the online delivery system 174 is depicted as connected to the automatic savings service 130 via the Customer Information Control System middleware, any other suitably secure connection methods may be used.

The mainframes 170 may also include a banking application 176, which facilitates actual transfer of funds between accounts of the merchant. For example, the daily transfer of accumulated transaction funds from checking to savings accounts through the automatic savings program may be facilitated via banking application 176. The exemplary application Hogan, depicted in the exemplary automatic savings system 100, is not limiting—any suitable banking application may be used for the purpose of funds transfer. Moreover, the banking application 176 is depicted as connected to the automatic savings service 130 via secure file transfer protocol, but other suitably secure connection methods may be used.

The mainframes 170 may also include a general ledger module 178, which maintains a general ledger for the merchant. As explained in more detail below, the automatic savings service 130 will create daily and monthly ledger files based on transactions performed in the automatic savings system 100. Such ledger files will be transferred to the general ledger module 178 for accounting purposes for the merchant. Again, the general ledger module 178 is depicted as connected to the automatic savings service 130 via secure file transfer protocol, but other suitably secure connection methods may be used.

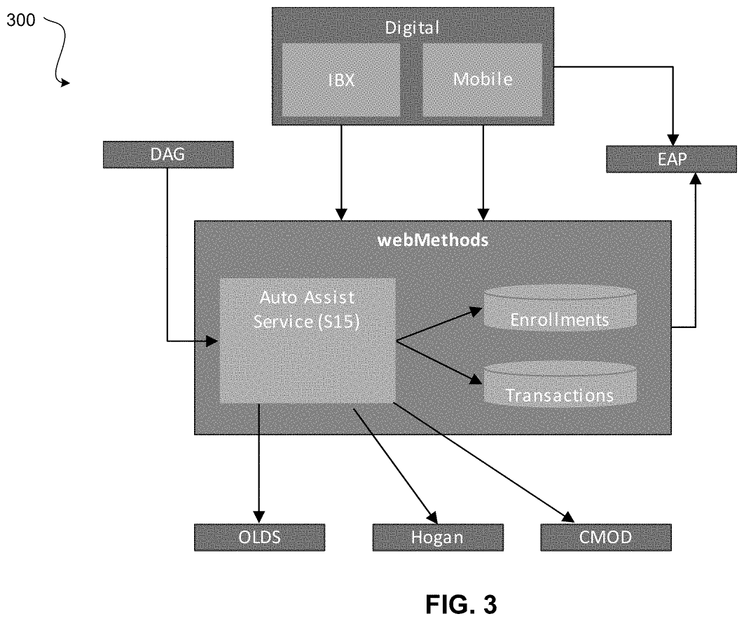

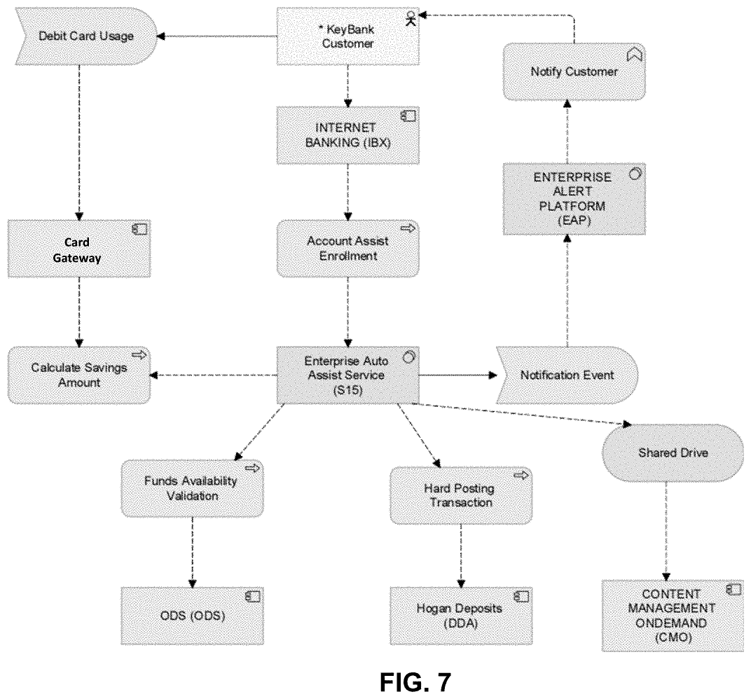

FIG. 3 depicts another exemplary arrangement of automatic savings system 300. The components and connections and interactions between them are similar to that described above for the exemplary system 100. Moreover, for completeness, a data flow diagram showing the interactions between the various components depicted in FIGS. 1 and 3 is shown in FIG. 7.

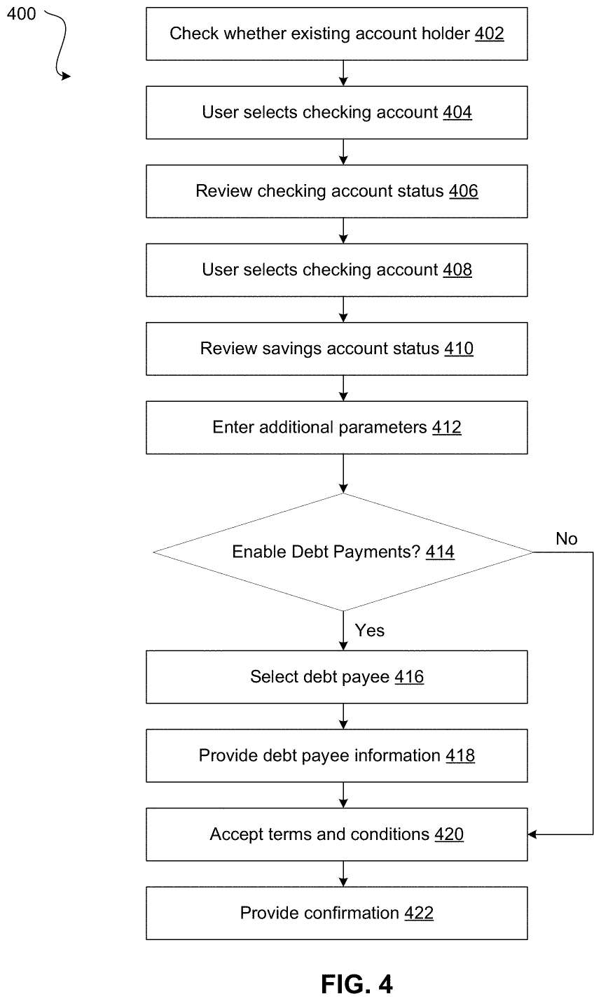

FIG. 4 depicts a flowchart for the enrollment process whereby a consumer enrolls in the automatic payment program according the present disclosure. At step 402, the system checks whether the consumer is an existing account holder. This check can be accomplished by a concurrent login (e.g., through use of cookies), or by requesting a user name or password of other identifying information of the consumer. If the user is not a current account holder, the user may be directed to a different online location where the user can create an account, or the user may be provided with other information (e.g., telephone or physical address) where a user can become an account holder. If the user is an existing account holder, at step 404, the user is asked to select a checking account. At step 406, the system checks the account status for the selected checking account. This analysis may involve checking whether account is open, whether the account has already been enrolled in the automatic savings program, whether it is a joint account, and whether account is eligible. In some embodiments, a single checking account will only be allowed to be enrolled once in the automatic savings program. The only-one-enrollment limitation may not be limited to individual consumers, for example if one user has enrolled a joint account in the automatic savings program, another holder of the same joint account may be prohibited from also enrolling that same account. Moreover, certain special accounts may be set as ineligible for the automatic savings program by the merchant either based on the account type (e.g., a health savings account) or the account holder, or if the account is closed or inactive. Note that the steps disclosed herein are not necessarily be performed in order. For example, the enrollment system may check the status of a user's accounts before presenting them to the user for selection, and the system may disable the ability for the user to select accounts that are already in use or ineligible and further may provide information as to why the account is not selectable.

At step 408, the user selects a savings account. At this time, the system and method contemplates a 1:1 relationship between checking and savings accounts, but it is possible that multiple checking accounts may be linked to a single savings account (i.e., transfers from multiple checking accounts will be made to one savings account based on transactions from each of those checking accounts) or that multiple savings account can be used (e.g., transfers from the checking account can be evenly divided among two or more savings accounts). At step 410, the system checks the account status for the selected savings account. This analysis may involve checking whether account is open, whether the account has already been enrolled in the automatic savings program, whether it is a joint account, and whether account is eligible. As with the checking account explained above, the savings account may be limited to single enrollment or restricted by eligibility. In addition, the savings account may have a maximum number of outflows, and in some embodiments, the account may not be eligible if there are already the maximum number of outflows being used by the account. In other embodiments, the account may still be eligible, but if the maximum number of outflows is reached, the automatic savings program may pause transfers until the outflow issue is resolved. In the case that the user has no available or eligible savings accounts, the user may be directed to a different online location where the user can open a new savings account, or the user may be provided with other information (e.g., telephone or physical address) where a user can create a savings account.

At optional step 412, the user may provide other account parameters. For example, the user may set the amount to be transferred from the checking account to the savings account with each card transaction. In some embodiments, the transfer amount is set to a default at enrollment and the user can change the amount after enrollment.

At step 414, the user will choose whether or not to elect the debt payment option. If not, the method will proceed to step 420. If the user does elect the debt payment option, then at step 416, user will choose a debt payee. The user may be allowed to search for an eligible debt payee or may be presented with a list of eligible debt payees from which to choose. In some embodiments, available debt payees are limited to only payees that are affiliated with the merchant offering the automatic savings program. In other embodiments, eligible payees also include any payee with a valid ACH FIS account. At step 418, the user will enter required information for their account with the debt payee, such as the debt account number (e.g., loan number) and any other information required for the merchant to access or make payments to the debt payee account.

At step 420, the user will be presented with terms and conditions for the automatic savings program and, in some embodiments, the user must perform some task (e.g., scrolling) indicating some modicum of review of the terms and conditions before accepting the terms and conditions by clicking a button, checking a box, or providing some other affirmative assent. In some embodiments, the acceptance of the terms and conditions at step 420 may occur earlier and the prior steps may be conditioned on the user first accepting the terms and conditions. For example, in some embodiments, a user may be required to accept the terms and conditions at step 420 before being allowed to enter the information at steps 414, 416 and 418. The steps of FIG. 4 need not be performed in the order shown. Finally, at step 422, the enrollment will be completed and a confirmation message may be displayed to the user. In some embodiments, in addition to or instead of displaying the confirmation message, a confirmation message may be sent to the customer via email, text message or other suitable communications means. The confirmation message may include a confirmation of the information entered and/or selected by the consumer and may also other information about the automatic savings program, such as the consumer potential savings and the benefits of the program.

Once enrolled, the customer may change aspects of their enrollment as described above in the exemplary user interface 200. In addition, the user may have the option to pause all or some of the automatic savings program or to unenroll. In some embodiments, the automatic payment system may include cut-off times for any changes to a user's program, and these cutoff times may be different for different aspects of the program. For example, the user may only have until a certain time of day to change account information or to pause or unenroll or a certain day of the month to change a debt payee. As a first step to processing any user changes, the system may first check whether the change is made after the stored cutoff time. If it is, the user may be informed that the change will not take effect until the following day (or other period). The user may then be given the option to proceed with the change or the cancel the change.

In some embodiments, the user may elect to pause the daily transfers from their checking account to their savings account under the automatic savings program. In the event that the user elects to pause transfers assuming the changed was made prior to any cutoff time for that day, any daily transfers from the user's checking to savings account will immediately cease. In some embodiments, pausing the daily transfers will not affect any scheduled payments to a debt payee. For example, if a payment to a debt payee is scheduled later in the month, the payment will still occur, and will be in the amount of all funds that were transferred from the checking account to the savings account under the program during that month period, which is stored in the system as a month-to-date total. After such payment is made, the month-to-date total will be reset to zero. Accordingly, if the program remains paused, on the next schedule debt payment date, the month-to-date total will still be zero and no debt payment will be made. Similarly, if the program is unpaused, the daily transfers from checking to savings will immediately resume (next day if past cutoff time) and the month-to-date total will again begin to accumulate. Then on the payment date, whatever amount has accumulated in the month-to-date total will be paid to the debt payee.

In a similar fashion, in some embodiments, the user may pause debt payments. If so, the daily transfers from checking to savings will still occur and the user will simply accumulate savings in the savings account. If debt payments are paused, when the set debt payment date occurs, no payment will be issued, but the month-to-date total will still be reset to zero. If the user unpauses debt payments, then on the next payment date, whatever amount has accumulated in the month-to-date total will be paid to the debt payee.

In some embodiments, the user may unenroll completely from the automatic savings program. Cutoff times notwithstanding, unenrolling will result in an immediate cessation of both monthly debt payments and daily transfers from checking to savings. The checking account, savings account and debt payee account will all become eligible to be enrolled again. Finally, both the month-to-date and total contribution amounts will be reset to zero and will begin again at zero if the consumer were to re-enroll in the program.

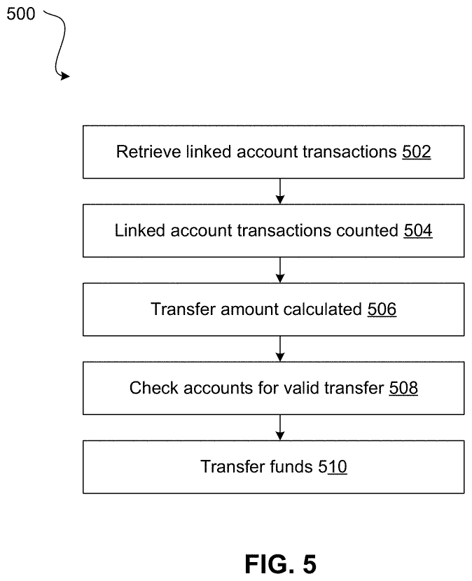

FIG. 5 depicts a flow chart for an exemplary daily operational process 500 of the automatic savings program. At step 502, a list of transactions for the card(s) and/or accounts linked to the automatic savings program are retrieved. At step 504, the number of transactions on that day is counted. In some embodiments refunds and credit transactions may be excluded from the count, and in some embodiments ATM transactions (such as withdrawals and deposits) may be included in the count. Note that in some embodiments, the system may simply retrieve the count, rather than receiving the list and then counting. At step 506, the count of transactions for that day is multiplied by a fixed transfer amount (which may be a default or may be user set) to calculate the total transfer amount. At step 508, the accounts are checked to ensure the transfer will be valid. This may include checking the account status to make sure it is active and/or checking the account eligibility, to make sure the account is eligible for the program. If the account is not active or eligible, the transfer may be canceled. In some embodiments, the user (and/or the system by default) may set a floor amount for the checking account, such that if the funds in the checking account are below the floor amount, the transfer will be canceled. If the transfer is canceled due to a balance being below the floor, the system may further send a report to an electronic repository for storing (e.g., CMOD). In some embodiments the system may allow an overdraw of the checking account resulting from the daily transfer via the automatic savings program, but without an overdraft fee being assessed. Finally, in step 510, the calculated funds are transferred from the designated checking account to the designated savings account.

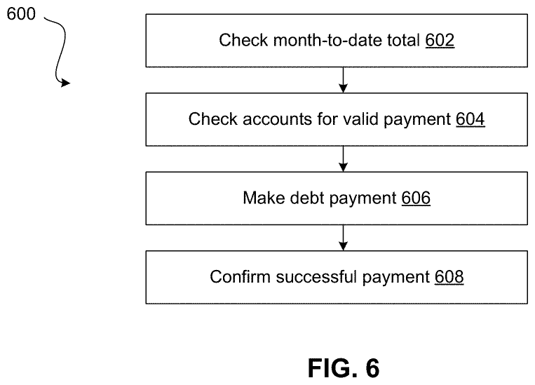

FIG. 6 depicts a flow chart for an exemplary monthly operational process 600 of the automatic savings program. On a preselected date each month, which may be defaulted (e.g., the third business day of each month) or selected by a customer, at step 602 the method begins by checking the month-to-date total for automatic savings program. Assuming that total is not zero, at step 604 the accounts are checked to ensure the transfer will be valid. This may include checking the account status to make sure it is active and/or checking the account eligibility, to make sure the account is eligible for the program. If the account is not active or eligible, the transfer may be canceled. Also at step 604, the account is checked to ensure there are sufficient funds to make the payment to the debt payee. Unlike the daily transfers, which are between two accounts of the same merchant, the debt payment will be canceled if there are not sufficient funds in the savings account to make the debt payment and an alert will be sent to the customer notifying them that the payment was unsuccessful due to insufficient funds. Finally, at step 608. the system may receive confirmation of a successful debt payment. In the event that a debt payment is rejected, then the system may pause debt payments going forward, return the funds to the customer's savings account and notifies the customer. As explained above, in the event debt payments are paused, daily transfers will still occur and accumulate in the customer's savings account.

Due to the nature of the disclosed system and method within the banking industry, it is imperative that the system create and maintain sufficient reporting regarding all the above-described transactions. Accordingly, it is contemplated that the system will create and maintain (preferably for at least seven years) a number of daily and monthly reports relating the automatic savings program. For example, the system may create and store (in CMOD) a daily report transaction report, which includes for each customer, checking account number, checking bank code, savings account number, savings bank code, number of transactions per day, aggregate number of transactions per cycle (payment date to payment date), dollar amount of transactions per day, aggregated dollar amount of transactions per cycle (payment date to payment date), settlement account, settlement bank code, payee ID, payee account number, total savings, week to date savings, month to date savings, year to date savings, life to date savings, digital ID, and date of enrollment. Another exemplary daily report is a file report by bank, which may include a count of debit items, count of credit items, sum of debit items, sum of credit items, account number, bank code, debit/credit amount, transaction code, debt payee name, transaction date, and transaction time.

In addition, the system can create and maintain (in CMOD) a number of monthly reports. For example, The system may create and maintain a monthly transaction report, which includes checking account number, checking bank code, savings account number, savings bank code, settlement account, settlement bank code, aggregate number of transactions per cycle (payment date to payment date), aggregate dollar amount of transactions per cycle (payment date to payment date), payee ID, payee account number, total savings, week to date savings, month to date savings, year to date savings, life time savings, digital ID, and date of enrollment. The system may also create and maintain a monthly rejected payment report and a monthly failed transfer report, which may include checking account number, checking bank code, checking account status, checking available balance, savings account number, savings bank code, savings account status, settlement account, settlement bank code, available balance in the savings account, reject reason, digital ID, and date/time. The system may further create and maintain a monthly debt payment report, which may include: savings account number, savings bank code, savings account status, savings available balance, reject reason, digital ID, date time.

Finally, the automatic payment system must also comply with general accounting practices. Accordingly, in one embodiment, the automatic payment service creates and transfers 12 files (one per month) to “deposits” and “Unitech Proof,” which provides error checking for the deposits, and creates a daily general ledger file with a credit total to offset debits to checking accounts and debit total to offset credits to savings accounts. Finally, the automatic payment service creates one file in the merchant's general ledger with monthly debits to offset a DDA settlement account and one credit entry to include all debt payments.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Accordingly, departures may be made from such details without departing from the spirit or scope of the applicant's general inventive concept.

1. A system for automatic savings, the system comprising:
a first bank account belonging to a user,
a second bank account belonging to the user,
a financial account belonging to the user, wherein the financial account may be one of the first bank account or second bank account;
wherein, a preset amount of monetary funds is automatically transferred from the first bank account to the second bank account when a transaction involving the financial account occurs.

2. The system of claim 1, further comprising an automatic savings service in communication with first bank account and second bank account through at least one banking application and facilitating the automatic transfer of the preset amount of monetary funds from the first bank account to the second bank account.

3. The system of claim 2, further comprising an enrollment database in communication with the automatic savings service and storing personal information of the user.

4. The system of claim 2, further comprising a transaction history database in communication with the automatic savings service and storing data relating to transactions involving the financial account.

5. The system of claim 2, further comprising a transfer history database in communication with the automatic savings service and storing data relating to fund transfers between the first and second account that were facilitated by the automatic savings service.

6. The system of claim 2, further comprising an alerts module, wherein the alerts module is configured to send an alert to the user upon one of the following: the user has completed enrollment in the system, a debt payee was added or changed in the system, a transaction occurred involving one of the user's accounts, a debt payment is upcoming, a debt payment is being skipped, a transfer was canceled due to insufficient funds, or a debt payment was rejected.

7. A system for automatic debt paydown, the system comprising:
a first bank account belonging to a user,
a second bank account belonging to the user,
a financial account belonging to the user, wherein the financial account may be one of the first bank account or second bank account;
wherein, a preset amount of monetary funds is automatically transferred from the first bank account to the second bank account when a transaction involving the financial account occurs; and
wherein, at the end of a set period, all monetary funds transferred from the first bank account to the second bank account as a result of transactions involving the financial account during that period are transferred to a debt payee specified by the user.

8. The system of claim 7, further comprising an automatic savings service that is:
in communication with first bank account and second bank account through at least one banking application and facilitating the automatic transfer of the preset amount of monetary funds from the first bank account to the second bank account; and
in communication with the debt payee through at least one financial information system and facilitating transfer of funds to the debt payee.

9. The system of claim 8, further comprising an enrollment database in communication with the automatic savings service and storing personal information of the user.

10. The system of claim 8, further comprising a transaction history database in communication with the automatic savings service and storing data relating to transactions involving the financial account.

11. The system of claim 8, further comprising a transfer history database in communication with the automatic savings service and storing data relating to fund transfers between the first and second account that were facilitated by the automatic savings service.

12. The system of claim 8, further comprising an online delivery system in communication with the automatic savings service that validates a balance of the first bank account prior to a transfer of funds from the first bank account facilitated by the automatic savings service.

13. The system of claim 8, further comprising an alerts module, wherein the alerts module is configured to send an alert to the user upon one of the following: the user has completed enrollment in the system, a debt payee was added or changed in the system, a transaction occurred involving one of the user's accounts, a debt payment is upcoming, a debt payment is being skipped, a transfer was canceled due to insufficient funds, or a debt payment was rejected.

14. A system for automatic savings and debt paydown, the system comprising:
a first bank account belonging to a user,
a second bank account belonging to the user,
a financial account belonging to the user, wherein the financial account may be one of the first bank account or second bank account;
a user interface providing the user with an option to select one of a savings mode or a debt paydown mode;
wherein, a preset amount of monetary funds is automatically transferred from the first bank account to the second bank account when a transaction involving the financial account occurs; and
wherein, if the debt paydown mode has been selected by the user via the user interface, at the end of a set period, all monetary funds transferred from the first bank account to the second bank account as a result of transactions involving the financial account during that period are transferred to a debt payee specified by the user.

15. The system of claim 14, further comprising an automatic savings service that is:
in communication with first bank account and second bank account through at least one banking application and facilitating the automatic transfer of the preset amount of monetary funds from the first bank account to the second bank account;
in communication with the debt payee through at least one financial information system and facilitating transfer of funds to the debt payee;
in communication with the user interface.

16. The system of claim 15, further comprising an enrollment database in communication with the automatic savings service and storing personal information of the user.

17. The system of claim 15, further comprising a transaction history database in communication with the automatic savings service and storing data relating to transactions involving the financial account.

18. The system of claim 15, further comprising a transfer history database in communication with the automatic savings service and storing data relating to fund transfers between the first and second account that were facilitated by the automatic savings service.

19. The system of claim 15, further comprising an online delivery system in communication with the automatic savings service that validates a balance of the first bank account prior to a transfer of funds from the first bank account facilitated by the automatic savings service.

20. The system of claim 15, further comprising an alerts module, wherein the alerts module is configured to send an alert to the user upon one of the following: the user has completed enrollment in the system, a debt payee was added or changed in the system, a transaction occurred involving one of the user's accounts, a debt payment is upcoming, a debt payment is being skipped, a transfer was canceled due to insufficient funds, or a debt payment was rejected.
